(19) United States
(12) Patent Application Publication
(10) Pub. No.: US 2009/0172986 A1
(43) Pub. Date: Jul. 9, 2009

(54) MEDIA DISPLAY DEVICE AND METHOD OF OPERATION THEREOF

(75) Inventors: Gilbert Fuchsberg, New York, NY (US); Eric Chan, New York, NY (US); Gary Natsume, Brooklyn, NY (US); Bernard Lo, Willowdale (CA); Joseph M. Jacobson, Newton, MA (US); Serge Rutman, Boulder Creek, CA (US); Mark Foster, Palo Alto, CA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: FIRSTPAPER LLC, New York, NY (US)

(21) Appl. No.: 12/248,331

(22) Filed: Oct. 9, 2008

Related U.S. Application Data
(60) Provisional application No. 60/978,717, filed on Oct. 9, 2007.
(60) Provisional application No. 60/978,722, filed on Oct. 9, 2007.
(60) Provisional application No. 60/978,748, filed on Oct. 9, 2007.
(60) Provisional application No. 60/978,723, filed on Oct. 9, 2007.

(51) Int. Cl. G09F 15/00

(52) U.S. Cl. 40/610

(57) ABSTRACT

Apparatus and methods for displaying types of information content based on the configuration of a media device are provided. The apparatus has a plurality of display panels flexibly coupled by one or more connectors. The display panels are flexibly coupled by the one or more connectors such that the display panels are capable of being arranged in a plurality of arrangements relative to one another. Each of the arrangements is indicative of a configuration of the device media. Each of the plurality of display panels has at least one viewing surface and is configured to display on the viewing surface a type of information content. The type of information content is indicative the configuration of the media device.

### CROSS REFERENCE TO RELATED APPLICATIONS

This application claims the benefit of, priority to and incorporates by reference herein U.S. provisional application number 60/978,717, titled “Foldable Media Device,” which was filed on Oct. 9, 2007. This application incorporates by reference herein in its entirety U.S. provisional application number 60/978,722, titled “Methods and Apparatus for a Content Distribution Network,” U.S. provisional application number 60/978,748, titled “Content Distribution and Preloading,” and U.S. provisional application number 60/978,723, titled “Methods and Apparatus For Local and On-line Data Services,” each of which was filed on Oct. 9, 2007. This application also incorporates by reference herein in its entirety U.S. non-provisional application titled “Methods, Apparatus, and Systems for Providing Local and Online Data Services,” and U.S. non-provisional application titled “Systems, Methods and Apparatus For Content Distribution,” each of which was filed on Oct. 9, 2008.

### FIELD OF THE INVENTION

The present invention relates to media devices, generally, and apparatus and methods for displaying information content on media devices, in particular.

### BACKGROUND INFORMATION

Conventional media devices may be designed to have fixed configurations and, as a result, a user of the device may have difficulty transporting the device and/or the device may waste precious space. Additionally, media devices may be designed to display information content on a predetermined number of display panels. As a result, a user may have difficulty reading the text or graphics provided on the display panel. Accordingly, it is desirable to have media devices that may be arranged in a number of configurations to improve portability, and/or that may display information content on one or more display panels according to the configuration of the media device.

### BRIEF DESCRIPTION OF THE DRAWINGS

Purposes and scope of the exemplary embodiments described below will be apparent from the following detailed description in conjunction with the appended drawings in which like reference characters are used to indicate like elements, and in which:

FIG. 1 is a perspective view of a media device in a partially expanded configuration according to an embodiment of the invention;

FIG. 2 is a perspective view of a media device in a partially expanded configuration according to another embodiment of the invention;

FIG. 3 is a block diagram representing circuitry of a display panel of the media device of FIG. 1 according to an embodiment of the invention;

FIG. 4 is a front view of a media device in a completely expanded configuration according to an embodiment of the invention;

FIG. 5 is a perspective view of a media device in a completely collapsed configuration according to an embodiment of the invention;

FIG. 6 is a flow chart of a method of operation of a media device according to one embodiment of the invention;

FIGS. 7A, 7B, 7C and 7D are side views of an electromechanical sensor according to an embodiment of the invention;

FIGS. 8A, 8B, 8C and 8D are side views of an electro-optical sensor according to an embodiment of the invention; and

FIG. 9 is a perspective view of a magnetically actuated proximity sensor according to an embodiment of the invention.

### SUMMARY OF EMBODIMENTS OF THE INVENTION

In one embodiment of the invention, an apparatus is provided. The apparatus includes a plurality of display panels flexibly coupled by one or more connectors such that the plurality of display panels are capable of being arranged in a plurality of arrangements relative to one another. Each of the plurality of display panels has at least one viewing surface and is configured to display on at least one viewing surface a type of information content indicative of a selected one of the plurality of arrangements.

In another embodiment of the invention, an apparatus is provided. The apparatus includes a plurality of display panels wherein each of the plurality of display panels has at least one viewing surface capable of displaying a selected one of a plurality of types of information content or being powered off. The apparatus also includes one or more connectors each flexibly coupling at least two of the plurality of display panels to enable a plurality of arrangements of the display panels. The apparatus also includes one or more sensors configured to sense a selected one of the plurality of arrangements of the display panels. The apparatus also includes a controller configured to receive information indicative of the sensed information. The controller may be also configured to, in response to the received information: determine the configuration of the apparatus, and select for display one of the plurality of types of information content or whether one or more of the plurality of display panels should be powered off. In response to the received information, the controller may also output data to one or more of the display panels to display on a viewing surface of at least one display panel the selected type of information content or power off the respective display panel.

In another embodiment of the invention, a method of operating a device having a plurality of display panels and respective viewing surfaces is provided. The method includes sensing an arrangement of a plurality of display panels relative to one another, and determining a configuration of the device based on the sensed arrangement of the plurality of the display panels. The method also includes, in response to determining that the device has a completely expanded configuration, displaying a composite image over a plurality of the viewing surfaces. The method also includes, in response to determining that the device has a completely collapsed configuration, displaying an individual image on the viewing surface facing outward from the device. The method also includes, in response to determining that the device does not have a completely expanded configuration or a completely collapsed configuration, displaying an individual image on any one of the plurality of the viewing surfaces.

### DETAILED DESCRIPTION OF EMBODIMENTS OF THE INVENTION

It is noted that in the figures, the illustration of components as separate entities from one another is merely exemplary. The components may be combined, integrated, separated and/or duplicated to support various applications. Additionally, the block diagrams and flow chart shown herein depict simplified views and may include additional or alternative elements or steps that are not depicted but which remain within the spirit of the embodiments of the invention described herein. All such alternative embodiments are envisaged by the inventors.

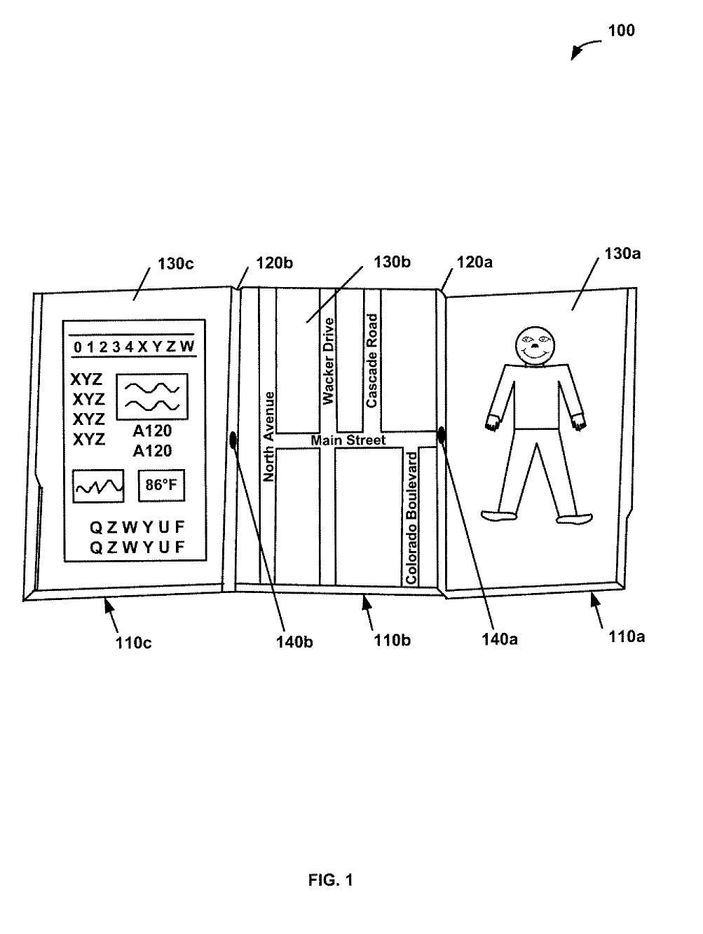

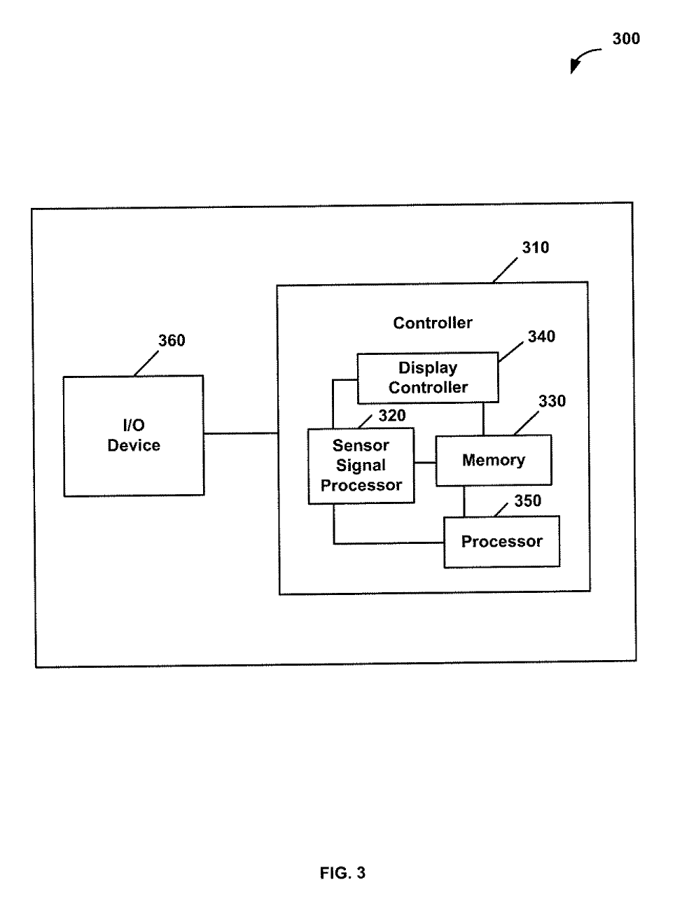

FIG. 1 is a perspective view of a media device in a partially expanded configuration according to an embodiment of the invention. FIG. 3 is a block diagram representing circuitry of a display panel of the media device of FIG. 1 according to an embodiment of the invention.

Referring to FIGS. 1 and 3, the device 100 may include a plurality of display panels 110a, 110b, 110c with respective first viewing surfaces 130a, 130b, 130c, connectors 120a, 12b, sensors 140a, 140b and circuitry 300. A connector 120a, 120b may be coupled between any two of the display panels 110a, 110b, 110c and one or more of the sensors 140a, 140b may be communicatively coupled to the connector 120a, 120b such that the sensors 140a, 140b can sense whether the connector 120a, 120b is flexed. The sensors 140a, 140b may be communicatively coupled to circuitry 300.

Each of the plurality of display panels 110a, 110b, 110c may have a first viewing surface 130a, 130b, 130c on which a textual and/or graphical display may be provided. The viewings surfaces 130a, 130b, 130c may include display pixels configured to be selectively powered on by row and column drivers. Alternately, in some embodiments, the first viewing surface 130a, 130b, 130c may be configured to display a blank screen. In some embodiments, a display panel having a first viewing surface may also have a second viewing surface. The first viewing surface may be on a first side of the display panel and the second viewing surface may be on a second side of the same display panel. In some embodiments, the second side of the display panel may be opposite the first side of the display panel, on the reverse side of the display panel. Display panels 110a, 110b, 110c may be configured to provide a display on the first viewing surface 130a, 130b, 130c and/or the second viewing surface.

In various embodiments, the display panels may be any type of display panel allowing display of textual and/or graphical information. In one embodiment, the display panels 110a, 110b, 110c may be substantially identical in structure or functionality. By way of example, but not limitation, each of the display panels 110a, 110b, 110c may be an E-ink e-paper display (“EPD”) panel. In another embodiment, one or more of the display panels may differ in structure or functionality. By way of example, but not limitation, one or more of the display panels 110a, 110b, 110c may be an EPD display panel, a thin film transistor (“TFT”)-based display panel and/or a touch-enabled display panel. TFT-based display panels may enable fast navigation speed, and/or precise color and video display.

Touch-enabled display panels may provide for device navigation, keyboard or virtual keypad functionality. Any touch technology may be used including, but not limited to, resistive or capacitive technologies. The touch technology may be the same on each of display panels 110a, 110b, 110c or the technology may differ across display panels 110a, 110b, 110c. For example, the technology may differ to support more complex capabilities, such as multi-finger input or pen-based input, or less complex capabilities, which may result in lower cost and/or lower power consumption.

In various embodiments, touch sensors (not shown) may be placed in a display area other than on the first viewing surface 130a, 130b, 130c. In one embodiment, the touch sensors may be placed in the bezel area of the first viewing surface 130a, 130b, 130c. In some embodiments, touch capability may be implemented by identifying an interruption (by a user's finger or otherwise) of an infrared beam provided to or from one or more of the display panels 110a, 110b, 110c. In some embodiments, the device 100 may have infrared touch capability without the use of bezels.

In other embodiments, the back of any display panel may include a capacitive button that operates as a touch pad or a rocker switch. The button may be used to interact with a type of information content displayed on the first viewing surface 130a, 130b, 130c and/or the second viewing surface of one of display panels 110a, 110b, 110c.

In one embodiment, one or more of the display panels 110a, 110b, 110c may be configured to display a blank screen or be a bistable display panel configured to provide a static display of the last image provided on the display panel before power was removed from or reduced in the display panel. The last image may be displayed until the power is applied to or increased in the display panel, and the image refreshed. In some embodiments, the bistable display panel may be the display panel of the E-ink® e-paper device, the Bridgestone Corporation QR-LPD® e-paper device or the display panel of other similar technology. Controlling one or more display panels independent of the other display panels may provide for decreased power consumption and battery conservation.

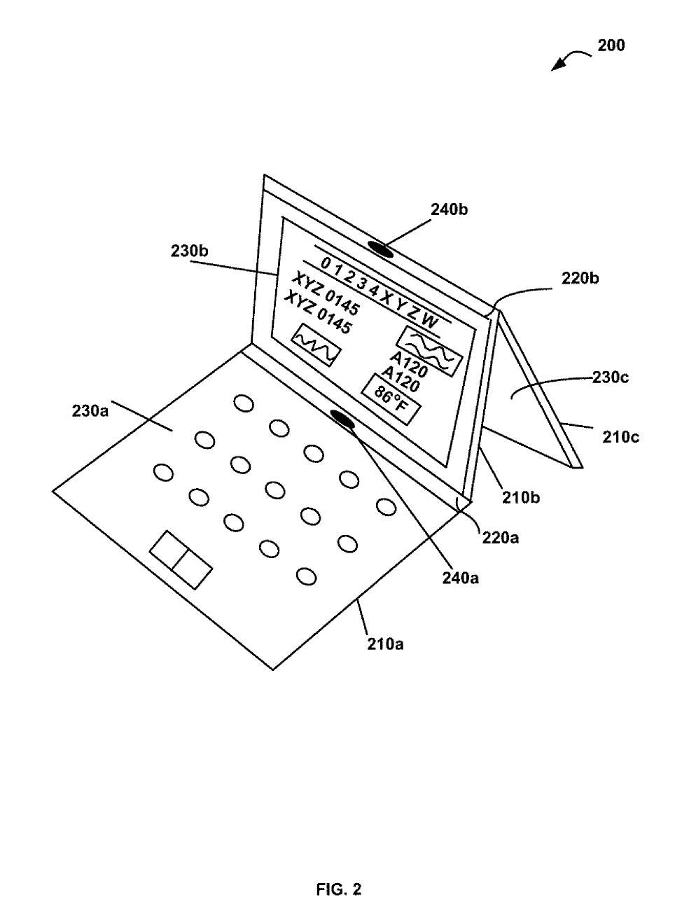

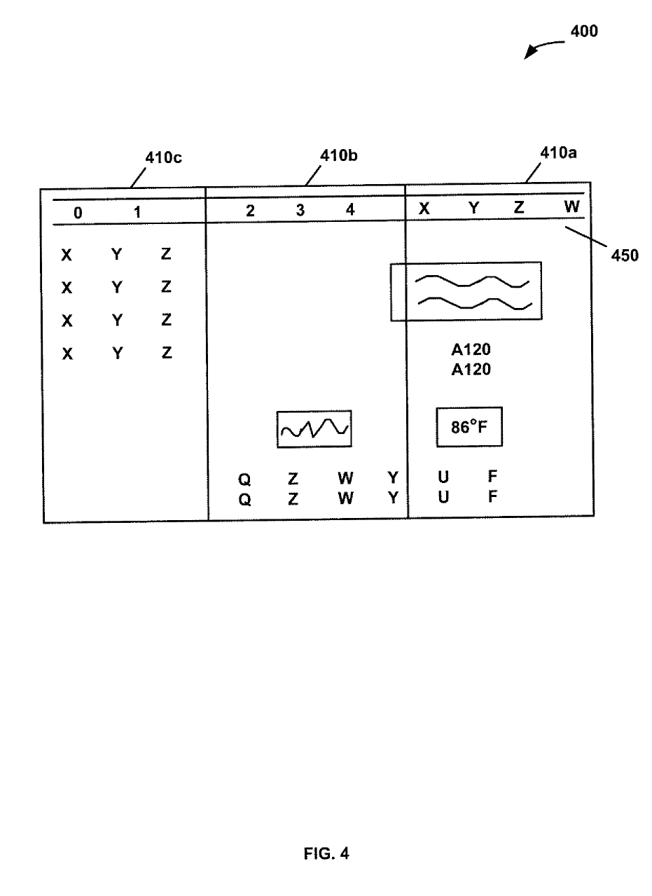

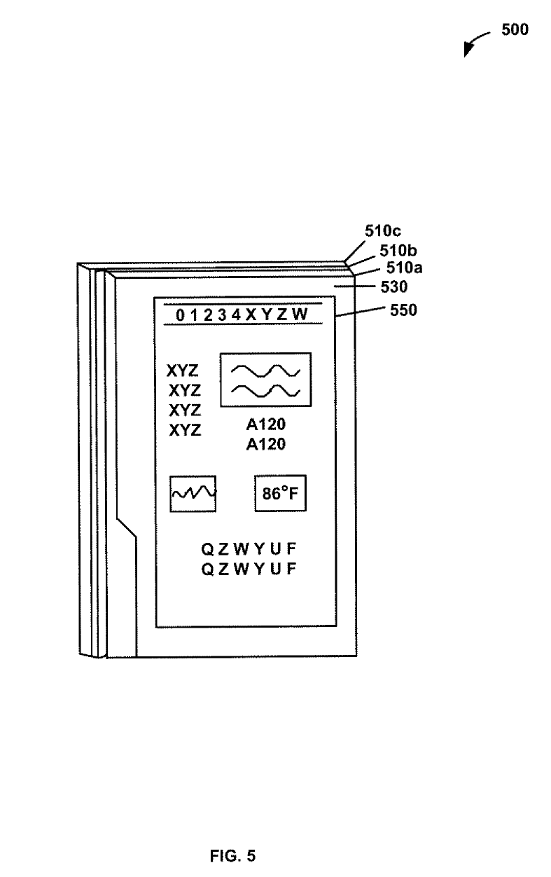

In one embodiment, each display panel 110a, 110b, 110c may be sufficiently thin to allow the device 100 to be completely collapsed. The display panel 110a, 110b, 110c may alternately be partially or completely expanded. As used herein, the term “completely expanded” means a configuration of the device wherein the first viewing surface of the leftmost display panel and the first viewing surface of the rightmost display panel form an angle of approximately 180 degrees (e.g., 180 degrees±2 degrees). In one embodiment, the device may be planar. FIG. 4 shows a device 400 in the completely expanded configuration. As used herein, the term “completely collapsed” means a configuration of the device wherein the first or second viewing surface of each of the display panels is substantially parallel to the first or second viewing surface of each of the other display panels. FIG. 5 shows a device 500 in the completely collapsed configuration. Providing display panels on a flexible substrate (e.g., aluminum or another suitable metal), display panels on a non-glass substrate, display panels lacking a backlight (e.g., OLED display panels), and/or display panels lacking a thick protective cover, may aid the device 100 in being completely collapsed by improving the likelihood of a substantial parallel arrangement of the first or second viewing surfaces of the display panels relative to one another. Referring to FIGS. 1 and 2, as used herein, the term “partially expanded” means a configuration of the device wherein the device is neither completely expanded nor completely collapsed. By way of example, but not limitation, in one embodiment of a partially expanded device, the first viewing surface of at least one of the display panels forms an angle with the first viewing surface of another display panel, and the formed angle is: other than 180 degrees, zero degrees and 360 degrees. FIGS. 1 and 2 show devices 100, 200 in the partially expanded configuration.

The connectors 120a, 120b may be any flexible material allowing the device 100 to be manipulated into a completely expanded configuration, a partially expanded configuration and/or a completely collapsed configuration. By way of example, but not limitation, the connectors 120a, 120b may be mechanical hinges, flexible plastic and/or cloth.

Any two of the display panels 110a, 110b, 110c may be coupled to one of the connectors 120a, 120b thereby coupling the two display panels together. In some embodiments, three or more display panels 110a, 110b, 110c may be coupled to a single connector.

In one embodiment, connectors 120a, 120b may also include communication media configured to transport information across the connectors 120a, 120b from one display panel to one or more of the other display panels. In one embodiment, the communication media may be adapted to communicate information by electrical signals. The communication media may include, but is not limited to, electrical conductors such as wires or flexible printed circuit traces. In various embodiments, electrical signals may be communicated according to the low voltage differential signaling (“LVDS”) method or another low power, high bandwidth method. In other embodiments, the connectors 120a, 120b may include communication media for communicating information from one display panel to another display panel by optical or RF signals or by any other method that does not require the inclusion of electrical signal conductors. By way of example, but not limitation, short-range infrared power may be communicated through the communication media or through the air surrounding the device 100, to provide optical communication between display panels. By way of another example, very short range RF may be used for RF communication between display panels. The transmitter and/or the receiver providing the optical and RF communication may be communicatively coupled to the connectors 120a, 120b or to any location on the device 100.

Sensor 140a may be communicatively coupled to connector 120a and sensor 140b may be communicatively coupled to connector 120b. In the embodiment shown, the sensors 140a, 140b may he coupled to their respective connector; however, such physical connection may not be required.

The sensors 140a, 140b may be any type of device adapted to sense whether, and/or the degree to which, one or more of the connectors 120a, 120b is flexed. By way of example, but not limitation, the sensors 140a, 140b may be adapted to sense the degree to which one or more connectors 120a, 120b are flexed. The sensing may be used to determine whether the first viewing surfaces 130a, 130b, 130c of the display panels 110a, 110b, 110c are substantially parallel to one another, thereby causing the connector to be flexed at an angle of zero degrees. By way of another example, but not limitation, the sensor may be adapted to sense the degree to which one or more connectors 120a, 120b are flexed. The sensing may be used to determine whether the first viewing surfaces 130a, 130b, 130c of the display panels 110a, 110b, 110 are not substantially parallel to one another, thereby causing the connector to be flexed at an angle other than zero degrees. Accordingly, the one or more sensors 140a, 140b may be adapted to sense a selected one of the possible arrangements of the display panels 110a, 110b, 110c.

The sensors 140a, 140b may operate based on electrical, optical or RF technology. In various embodiments, the one or more sensors 140a, 140b may be electromechanical contacts, optical sensors, proximity sensors, camera arrays and/or strain gauges. In one embodiment, one or more of the sensors 140a, 140b may be the thin film Bend Sensor® manufactured by Flexpoint Flexible Sensor Systems of Draper, Utah, the optical HiTechnic NXT Color Sensor manufactured by HiTechnic and/or the Cypress Semiconductor proximity sensor such as that of the Cypress Semiconductor CY3235 kit.

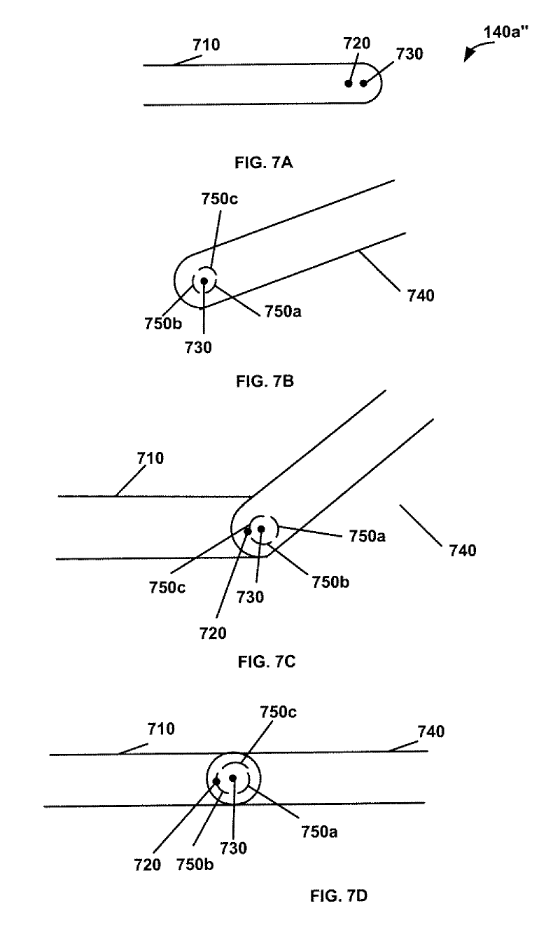

FIGS. 7A, 7B, 7C and 7D are side views of an electromechanical sensor according to an embodiment of the invention. With reference to the figures collectively, an embodiment of a sensor 140a may be displayed as shown with reference to sensor 140a″. Sensor 140a″ may include panels 710, 740 that may be coupled by a hinge to one another at hinge axis 730. Panel 710 may include a sensing mechanism 720 configured to sense one or more voltage levels (e.g., 1, 2 or 3 volts) while panel 740 may include a number of electrical contacts 750a, 750b, 750c configured to provide the one or more voltage levels sensed by the sensing mechanism 720. Referring to FIGS. 1, 7C and 7D, panels 710, 740 may be oriented in the configuration shown based on the degree to which the connector is flexed (in embodiments wherein the sensor 140′ is coupled to the connector). The orientation shown in FIG. 7C is indicative of the device 100 wherein at least one connector is flexed thereby resulting in a partially expanded configuration such as that shown in FIG. 1. In FIG. 7C, the sensing mechanism 720 senses the selected voltage level provided by electrical contact 750c; while in FIG. 7D, the sensing mechanism 720 senses the voltage level provided by electrical contact 750b. The orientation shown in FIG. 7D is indicative of the device 400, which has a completely expanded configuration. Accordingly, the degree to which the connector 120a may be flexed may be determined by sensing the voltage level, determining the electrical contact 750a, 750b, 750c providing the sensed voltage level and determining the corresponding arrangement of the display panels coupled by the connector 120a.

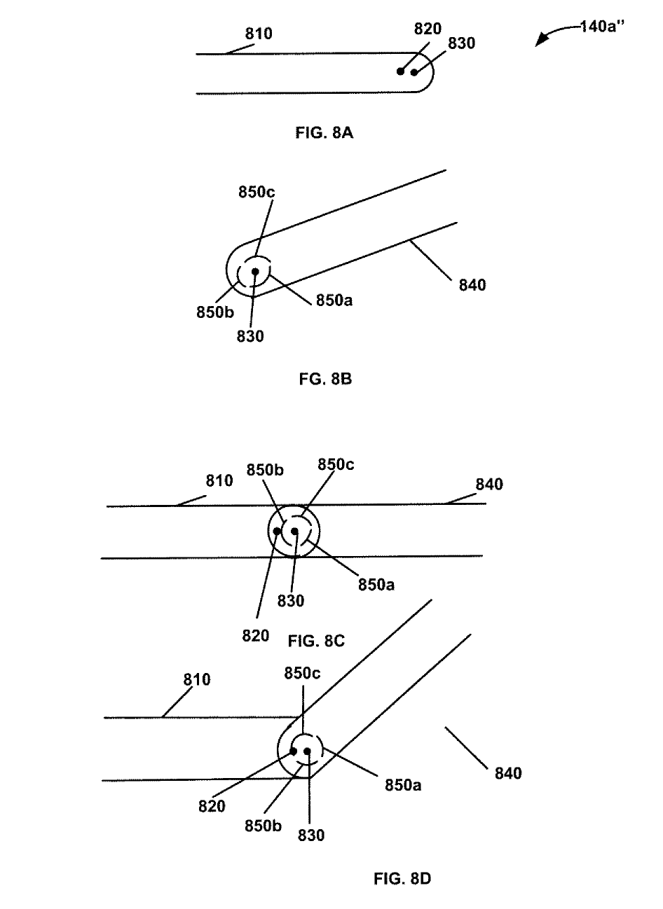

FIGS. 8A, 8B, 8C and 8D are side views of an electro-optical sensor according to embodiments of the invention. With reference to the figures collectively, an embodiment of a sensor 140a may be displayed as shown with reference to sensor 140a″. Sensor 140a″ may include two panels 810 and 840 that may be coupled by a hing to one another at hinge axis 830. Panel 810 may include a photodetector 820 (or any other electro-optical sensing mechanism) configured to sense one or more colors of light (e.g., red, blue or green light) as a result of the output of elements 850a, 850b, 850c on panel 840. Referring to FIGS. 1, 8C and 8D, panels 810, 840 may be oriented in the configuration shown based on the degree to which the connector is flexed (in embodiments wherein the sensor 140″ is coupled to the connector). The orientation shown in FIG. 8D is indicative of the device 100 wherein at least one connector is flexed thereby resulting in a partially expanded configuration such as that shown in FIG. 1. In FIG. 8D, the photodetector 820 senses the selected output (e.g., corresponding to green light) provided by element 850c; while in FIG. 8C, the photodetector 820 senses a different output (e.g., corresponding to red light) provided by element 850b. The orientation shown in FIG. 8C is indicative of the device 400, which has a completely expanded configuration. Accordingly, the degree to which the connector may be flexed may be determined by sensing the output from the elements 850a, 850b, 850c, determining the element providing the sensed output and determining the corresponding arrangement of the display panels coupled by the connector 120a.

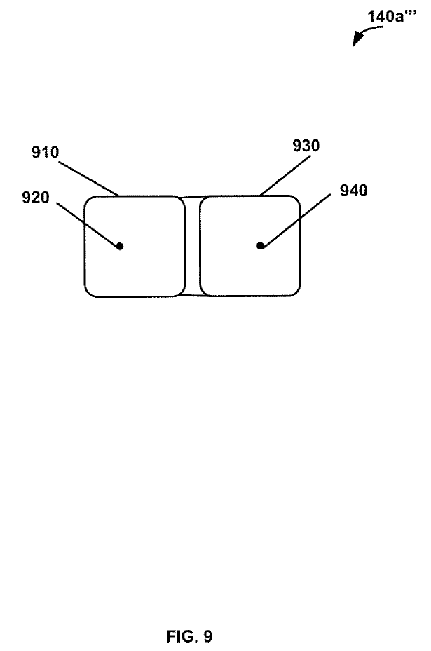

FIG. 9 is a perspective view of a magnetically actuated proximity sensor according to an embodiment of the invention. The sensor may include panel 910 having a magnetically actuated relay 920 and panel 930 having a magnet 940. In another embodiment, the magnet 940 may be replaced by a slug of ferrous metal that may cause the capacitance in an associated RC circuit (not shown) to change based on the proximity of the ferros slug. The capacitance may increase as the ferros slug is moved closer to the magnetically actuated relay 920, and decrease as the ferros slug is moved away from the magnetically actuated relay 920. A reduction in the resonant frequency of the RC circuit may then occur due to the increased capacitance.

The circuitry 300 may be adapted to receive from one or more of the sensors 140a, 140b sensed information regarding the arrangement of the display panels 110a, 110b, 110c, and determine the configuration of the device 100 based on the sensed information. The circuitry 300 may also be configured to control one or more of the display panels 110a, 110b, 110c to provide a display of a type of information content from the first viewing surface 130a, 130b, 130c, and/or the second viewing surface (not shown) of the respective display panel 110a, 110b, 110c. The circuitry 300 may also control a display panel to display a type of information content that is a single image on a selected one or more of the display panels, or a composite image across a plurality of the display panels. The control information may be communicated between one or more display panels via the connectors 120a, 120b, which may be communicatively coupled to the controller 310.

In one embodiment of the operation, the I/O device may receive information sensed by one or more of the sensors 140a, 140b and output the information to the sensor signal processor 320 of the controller 310. The sensor signal processor 320 may be adapted to determine whether and/or the degree to which one or more of the controllers 120a, 120b is flexed. The sensor signal processor 320 may output information indicative of the configuration of the device 100 to the display controller 340. The display controller 340 may output control information through the I/O device 360 to one or more row and/or column drivers that may be communicatively coupled to pixels (not shown) associated with display panels 110a, 110b, 110c. The control information may control one or more row and/or column drivers to display a type of information content indicative of the determination made by the sensor signal processor 320 and/or cause the power to the display panel 110a, 110b, 110c to be reduced or modified. Accordingly, in some embodiments, the device 100 may conserve power by having one or more display panels selectively turned off.

In one embodiment, circuitry 300 may be communicatively coupled to each of the display panels 110a, 110b, 110c and may control each of the display panels 110a, 110b, 110c. In another embodiment, circuitry 300 may be communicatively coupled to a single display panel for controlling only the display of a single display panel. In the latter embodiment, each display panel 110a, 110b, 110c may be controlled by individual circuitry 300. For example, each of display panels 110a, 110b, 110c may be controlled by a circuit similar in connectivity and/or function of circuitry 300.

In operation, the type of information content displayed may be selected according to the arrangement of the display panels 110a, 110b, 110c relative to one another. A user of the device 100 may arrange the display panels 110a, 110b, 110c in a selected one of a plurality of possible arrangements, which result in a selected configuration of the device. The configuration may be a partially or completely expanded configuration or a completely collapsed configuration.

As shown in FIG. 1, when the device 100 is in a partially expanded configuration, the type of information content may be a display of a single image 150a, 150b, 150c on one or more of the viewing surfaces 130a, 130b, 130c of the display panels 110a, 110b, 110c.

As shown in FIG. 5, when the device 500 is in a completely collapsed configuration, the device 500 may display a type of information content on an outer viewing surface 530 of only a single display panel 510a. The device 500 may display a type of information content on any viewing surface that may be viewed by a user of the device 500 when the device 500 is in the completely collapsed configuration. The completely collapsed configuration may advantageously occupy less space than the device 500 in the completely expanded or partially expanded configurations.

In other embodiments, when the device 500 is in a completely collapsed configuration, the device 500 may provide a bistable display or a blank screen on one or more of the display panels 510a, 510b, 510c.

FIG. 4 is a front view of a device in a completely expanded configuration according to an embodiment of the invention. When the device 400 is in the completely expanded configuration, the type of information content may be displayed as a composite image across two or more of the first viewing surfaces 430a, 430b, 430c of the display panels 410a, 410b, 410c.

With reference to FIGS. 1, 2, 4 and 5, in various embodiments, the information content may be any type of information that may be provided by the news, sports, weather, navigation media or any other information received at or stored within the device 100, 200, 400, 500. In various embodiments, the information may be selected dynamically from time to time as a result of a user's personal preference. Further, by way of example but not limitation, the type of information content may be a dynamic or static graphical and/or textual image or a blank screen. In other embodiments, the device 100, 200, 400, 500 may provide information content for facilitating the receipt of input at the device 100, 200, 400, 500. By way of examples but not limitation, the type of information content may be a virtual keyboard, virtual keypad, windows-based display, pen-based user interface (“PUI”) icon display, interactive add-ons and/or any other display configured to facilitate the entry of an input from the user of the device 100, 200, 400, 500.

The power provided to the devices 100, 200, 400, 500 or the controller 300, which may be communicatively coupled to or provided within the devices 100, 200, 400, 500, may be provided by way of various different embodiments. In one embodiment, the power may be provided by electrical signal conductors such as wires, or by flexible printed circuit traces coupled to a battery subsystem. In some embodiments, the battery subsystem may include individual batteries respectively coupled to each display panel of the device 100, 200, 400, 500. In another embodiment, power may be provided by operably coupling the device 100, 200, 400, 500 to a power plug that may be connected to an electrical socket, and/or operably coupling the device 100, 200, 400, 500 to a solar cell.

In another embodiment, power may be provided via surface contacts that provide an electrical path when the device 100, 200, 400, 500 is completely collapsed, but are not connected to the device 100, 200, 400, 500 when the device 100, 200, 400, 500 is completely or partially expanded. In yet another embodiment, the power may be provided inductively. The latter two aforementioned embodiments may advantageously enable the outer surface of the device 100, 200, 400, 500 to be sealed to improve the protection of the device from moisture and dust, and enable less complex and slimmer connectors.

Referring to FIGS. 1, 2, 3, 4 and 5, the devices 100, 200, 400, 500 may be designed to be communicatively coupled to a bridging device (not shown) for receiving information input from the bridging device. The bridging device may be a laptop, personal computer, cellphone, personal digital assistant (“PDA”), televisions, such as Advanced Television Systems Committee (“ATSC”)-M/H, traditional or satellite radios and/or any other device configured to output information content to a device 100, 200, 400, 500. The interface between the devices 100, 200, 400, 500 and the bridging device may be wired or wireless. By way of examples but not limitations, wired interfaces may include, but are not limited to, universal serial bus (“USB”), mini-USB, Apple FireWire®, electrical or optical interfaces. By way of examples but not limitations, wireless interfaces may include, but are not limited to, Bluetooth® or Wi-Fi interfaces.

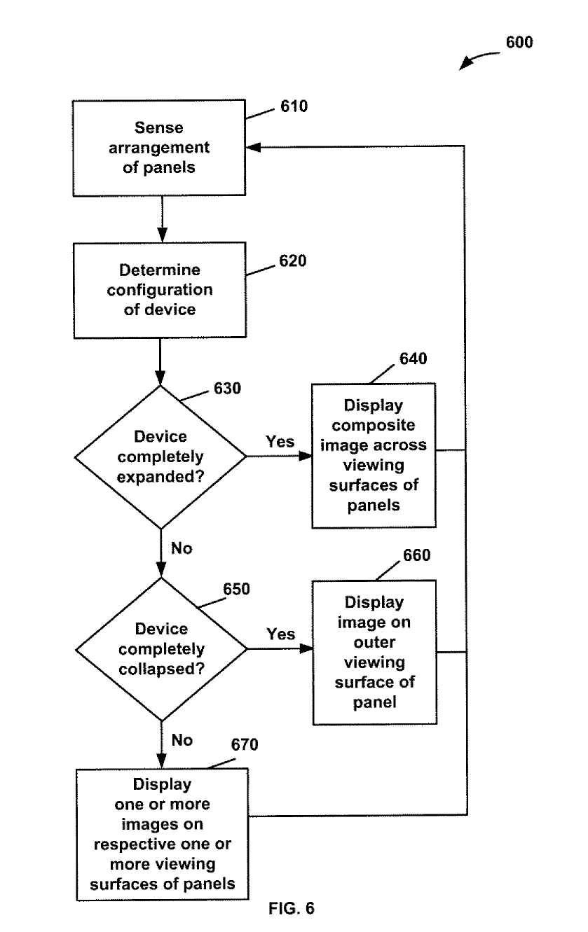

FIG. 6 is a flow chart of a method of operation of a media device according to one embodiment of the invention. In the embodiment shown, the arrangement of the display panels relative to one another may be sensed 610. The configuration of the device may be determined based on the sensed information 620. A determination may be made as to whether the device is completely expanded 630.

If the device is determined to be completely expanded, two or more display panels may be controlled to display a composite image 640 on their respective viewing surfaces. With reference to FIGS. 4 and 6, in one embodiment, the composite image 450 may be displayed across two or more of the first viewing surfaces 430a, 430b, 430c of each of the display panels 410a, 410b, 410c. The image 450 may be indicative of a selected type of information content that is indicative of the sensed arrangement of the panels 410a, 410b, 410c and/or the overall configuration of the device 400.

With reference to FIG. 6, if it is determined that the device is not completely expanded, a determination may be made as to whether the device is completely collapsed 650. If the device is determined to be completely collapsed, one or more display panels may be controlled to display an image 660 on one or more of the outer viewing surfaces of the display panels. With reference to FIGS. 5 and 6, in one embodiment, the image 550 may be provided on a single, outer viewing surface 530 of display panel 510a. The image 550 may be indicative of a selected type of information content that is indicative of the sensed arrangement of the panels 510a, 510b, 510c and/or the overall configuration of the device 500.

If it is determined that the device is not completely collapsed, one or more display panels may be controlled to display one or more images on the respective one or more viewing surfaces of the display panels 670. As shown in FIGS. 1 and 2, the image may be indicative of a selected type of information content that is indicative of the sensed arrangement of the panels and/or the overall configuration of the device. For example, with reference to FIGS. 2 and 6, the arrangement of the panels 210a, 210b, 210c may be sensed by sensors 240a, 240b on connectors 220a, 220b. The sensed arrangement may be amenable to the controller (not shown) controlling the device 200 to display a virtual keyboard on first viewing surface 230a of the panel 210a, a graphical or textual image on first viewing surface 230b of panel 210b, and any other image, including, but not limited to, a bistable display image or a blank screen, on first viewing surface 230c of panel 210c. In some embodiments, the connector 220b may be a mechanical hinge configured to maintain the device 200 in the configuration shown in FIG. 2 so that the user of the device 200 may be able to easily view the first viewing surface 230b.

In some embodiments, the method may also or alternately control the one or more display panels to display a type of information content having a selected function based on whether a determination is made that the device is completely expanded, completely collapsed or partially expanded. The type of information content may include, but is not limited to, a virtual keyboard, a virtual keypad, a textual display, a graphics display or a blank screen.

For example, if the method senses that the device is configured in a manner that would provide easy viewing of the display panels for a user but somewhat complicated input capability, the device may be controlled to provide mere graphical or textual displays of information, such as that shown in FIG. 1.

As another example, if the method senses that the device is configured in a manner that would provide easy input capability for a user, the device may be controlled to provide a display facilitating input of information from a user of the device and a display of information, such as that shown in FIG. 2. As shown in FIG. 2, the device may be controlled to provide a display of a virtual keyboard. Further, in FIG. 2 or in any of the embodiments disclosed herein, the power to one or more of the display panels may be changed due to visibility of the display panel to the user. In device configurations wherein one or more display panels are not easily viewable by the user based on the configuration of the device, the power to the display panel may be reduced or removed altogether to conserve power. Referring to FIG. 2, for example, the power to display panel 210c may be reduced or removed altogether because the display panel is not easily viewable by the user while the user is using the virtual keyboard and information content displayed on the first viewing surfaces 230a, 230b of display panels 210a, 210b.

While the embodiments shown in FIGS. 1, 2, 4 and 5 described herein include sensors that sense information indicative of the arrangement of the display, and the controller correspondingly outputs data to the one or more display panels, in one embodiment, a device according to an embodiment of the invention may be formed without sensors.

In another embodiment, a device may be manually configured to override the functionality of a sensor signal processor. For example, the device may be manually configured by receiving from a user of the device inputs indicative of selected device settings. In some embodiments, the input may be received in response to a virtual menu of device setting options provided on a display panel of the device. The device settings may include, but are not limited to, the configuration of the device, the arrangement of one or more of the display panels, a desired type of information content to display on one or more of the display panels, whether to display the information content as a single image on one or more display panels, a selected display panel on which to display the information content, and/or whether to display the information content as a composite image across one or more display panels.

While the embodiments shown in the figures include three display panels, three first viewing surfaces two connectors and two sensors, other embodiments of the invention may include different numbers of the aforementioned components.

Additionally, in the instant specification, various exemplary embodiments have been described with reference to the accompanying drawings. It will, however, be evident that various modifications and/or changes may be made thereto, and/or additional embodiments may be implemented, without departing from the broader scope of the invention as set forth in the claims that follow. The specification and/or drawings are accordingly to be regarded in an illustrative rather than a restrictive sense.

What is claimed is:

1. An apparatus comprising a plurality of display panels flexibly coupled by one or more connectors such that the plurality of display panels are capable of being arranged in a plurality of arrangements relative to one another forming one of a plurality of configurations of the apparatus, each of the plurality of display panels having at least one viewing surface and being configured to display on the at least one viewing surface a type of information content indicative of a selected one of the plurality of configurations.

2. The apparatus of claim 1, wherein the apparatus is also configured to power on or off one or more of the plurality of display panels in response to the selected one of the plurality of configurations.

3. The apparatus of claim 1, wherein the selected one of the plurality of configurations is one wherein the viewing surfaces of each of the plurality of display panels collectively form an angle of approximately 180 degrees relative to one another.

4. The apparatus of claim 3, wherein the type of information content is displayed as a composite image across a plurality of the viewing surfaces.

5. The apparatus of claim 1, wherein the selected one of the plurality of configurations is one wherein the display panels are substantially parallel to one another.

6. The apparatus of claim 5, wherein the type of information content is displayed on at least one of the viewing surfaces facing outward from the apparatus.

7. An apparatus comprising:
a plurality of display panels, each of the plurality of display panels having at least one viewing surface capable of displaying a selected one of a plurality of types of information content or of being powered off;
one or more connectors, each of the one or more connectors flexibly coupling at least two of the plurality of display panels to enable a plurality of arrangements of the display panels relative to one another;
one or more sensors configured to sense a selected one of the plurality of arrangements of the display panels; and
a controller configured to receive information indicative of the sensed selected one of the plurality of arrangements and, in response to the received information:
determine the configuration of the apparatus;
select one of the plurality of types of information content or whether one or more of the plurality of display panels should be powered off; and
output data to one or more of the display panels to display on the viewing surface of at least one display panel the selected type of information content or power off one or more of the respective display panels.

8. The apparatus of claim 7, wherein the type of information content is selected from the group consisting of: a virtual keyboard, a virtual keypad, a textual display, a graphics display and a blank screen.

9. The apparatus of claim 7, wherein the selected one of the plurality of configurations is one wherein the viewing surfaces of each of the plurality of display panels collectively form an angle of approximately 180 degrees relative to one another.

10. The apparatus of claim 9, wherein the type of information content is displayed as a composite image across a plurality of the viewing surfaces.

11. The apparatus of claim 7, wherein the selected one of the plurality of configurations is one wherein the display panels are substantially parallel to one another.

12. The apparatus of claim 1, wherein the type of information content is displayed on at least one of the viewing surfaces facing outward from the apparatus.

13. The apparatus of claim 7, wherein each of the one or more connectors comprises circuitry for communicating data between at least two of the plurality of display panels for displaying the type of the information content.

14. The apparatus of claim 13, wherein the data is output to the one or more display panels by low-voltage differential signaling.

15. The apparatus of claim 7, wherein the data is output to the one or more display panels by infrared transmission.

16. A method of operating a device having a plurality of display panels and respective viewing surfaces, the method comprising:
sensing an arrangement of a plurality of display panels relative to one another;
determining a configuration of the device based on the sensed arrangement of the plurality of the display panels;
in response to determining that the device has a completely expanded configuration, displaying a composite image over a plurality of the viewing surfaces;
in response to determining that the device has a completely collapsed configuration, displaying an individual image on the viewing surface facing outward from the device; and
in response to determining that the device does not have a completely expanded configuration or a completely collapsed configuration, displaying an individual image on any one of the plurality of the viewing surfaces.
